(19) United States
(12) Patent Application Publication
(10) Pub. No.: US 2023/0271375 A1
(43) Pub. Date: Aug. 31, 2023

(54) SHAPING DEVICE AND SHAPING METHOD

(71) Applicant: MITSUBISHI HEAVY INDUSTRIES, LTD., Tokyo (JP)

(72) Inventors: Yusei KONDO, Tokyo (JP); Masayuki KANEMASU, Tokyo (JP); Hiromichi AKIYAMA, Tokyo (JP); Kazuki NOMA, Tokyo (JP); Toshio KOZASA, Tokyo (JP)

(21) Appl. No.: 18/018,278

(22) PCT Filed: Sep. 1, 2020
(86) PCT No.: PCT/JP2020/033012

§ 371 Date: Jan. 27, 2023

(51) Int. Cl. B29C 53/04; B29C 70/44

(52) U.S. Cl. CPC B29C 53/04; B29C 70/44

(57) ABSTRACT

A shaping device which forms a fiber sheet into a shape having a shape change section, said shaping device comprising: a shaping mold which is provided to one side of the fiber sheet and serves as a mold for shaping the fiber sheet; a supporting member which has greater rigidity than the fiber sheet and is provided to the other side of the fiber sheet and to an area in which the shape change section is formed; a covering member that covers the fiber sheet; and a pressing device that presses the fiber sheet onto the shaping mold by means of the covering member. The pressing device is a suction device that suctions the atmosphere from between the shaping mold and the covering member.

### TECHNICAL FIELD

The present disclosure relates to a shaping device and a shaping method.

### BACKGROUND ART

In the related art, there is known a system for minimizing wrinkles occurring during shaping of a composite material (refer to, for example, PTL 1). In this system, the composite material is disposed on a tool so as to cover an embossing rod assembly. The embossing rod assembly has an embossing rod that corrugates the composite material when compressive pressure is applied to the composite material, and the occurrence of wrinkles is suppressed by the embossing rod.

### CITATION LIST

### Patent Literature

[PTL 1] United States Patent Application, Publication No. 2017-0312999

### SUMMARY OF INVENTION

### Technical Problem

Incidentally, in a case where compressive pressure is applied to the composite material, the composite material is covered with a covering member such as a vacuum bag and evacuation is performed. In a case where a composite material having shape change portions such as corners is shaped by using a covering member, wrinkles may occur at a corner portion, so that there is a possibility that poor shaping may occur. In PTL 1, although the wrinkles of the composite material are smoothed out by the embossing rod, the composite material is corrugated.

Therefore, the present disclosure has an object to provide a shaping device and a shaping method in which it is possible to suitably shape a fiber sheet having a shape change portion.

### Solution to Problem

A shaping device of the present disclosure is a shaping device for shaping a fiber sheet into a shape having a shape change portion, the shaping device including: a shaping tool that is provided on one side of the fiber sheet and serves as a die material for shaping the fiber sheet; a supporting member that has higher rigidity than the fiber sheet and is provided on the other side of the fiber sheet and provided at a portion where the shape change portion is formed; a covering member that covers the fiber sheet; and a pressing device that presses the fiber sheet against the shaping tool with the covering member.

A shaping method of the present disclosure is a shaping method for shaping the fiber sheet into a shape having the shape change portion by using the shaping device described above, the method including: a step of disposing the fiber sheet with respect to the shaping tool; a step of disposing the supporting member on an opposite side of the shaping tool with the fiber sheet interposed therebetween, corresponding to a portion where the shape change portion is formed, before or after the step of disposing the fiber sheet; a step of disposing the covering member to cover the fiber sheet; and a step of pressing the fiber sheet against the shaping tool with the covering member.

### Advantageous Effects of Invention

According to the present disclosure, it is possible to suitably shape a fiber sheet having a shape change portion.

### BRIEF DESCRIPTION OF DRAWINGS

FIG. 1 is a schematic diagram relating to a shaping device before suction according to Embodiment 1.

FIG. 2 is a schematic diagram relating to the shaping device after suction according to Embodiment 1.

FIG. 3 is a schematic diagram relating to disposition of a fiber sheet according to Embodiment 1.

FIG. 4 is an explanatory diagram comparing the shaping in the related art with the shaping in Embodiment 1.

FIG. 5 is a schematic diagram of a shaping device according to Embodiment 2.

FIG. 6 is a schematic diagram relating to disposition of a supporting member of a shaping device according to Embodiment 3.

FIG. 7 is a schematic diagram relating to disposition of a supporting member of a shaping device according to Embodiment 4.

FIG. 8 is a schematic diagram of the shaping device according to Embodiment 4.

FIG. 9 is a schematic diagram of a shaping device according to Embodiment 5.

FIG. 10 is a schematic diagram of a shaping device according to Embodiment 6.

FIG. 11 is a schematic diagram of a shaping device according to Embodiment 7.

FIG. 12 is a schematic diagram of a shaping device according to Embodiment 8.

FIG. 13 is an explanatory diagram of a shaping method according to Embodiment 9.

### DESCRIPTION OF EMBODIMENTS

Hereinafter, embodiments according to the present disclosure will be described in detail based on the drawings. The present invention is not limited by these embodiments. Further, components in the following embodiments include components that can be easily replaced by those skilled in the art, or components that are substantially the same as them. Further, the components described below can be appropriately combined, and in a case where there are a plurality of embodiments, each embodiment can also be combined.

### Embodiment 1

A shaping device 10 according to Embodiment 1 is a device for shaping a fiber sheet S having a shape change portion D. The shape change portion D is, for example, a bent portion, a curved portion, a stepped portion, or the like, and is a portion that changes when a planar shape is deformed into a different shape. Specifically, in Embodiment 1, the fiber sheet S to be shaped is two-dimensionally deformed within an orthogonal plane orthogonal to a longitudinal direction with a predetermined direction defined as the longitudinal direction. Then, in Embodiment 1, the shape change portion D is a portion whose shape is further changed within a plane along the longitudinal direction. That is, the shape change portion D is a portion at which the fiber sheet S, which changes two-dimensionally, is changed three-dimensionally. Therefore, the fiber sheet S after shaping is a three-dimensionally (stereoscopically) deformed fiber sheet. The shape change portion D is not particularly limited to the above, and may be any portion as long as it is a portion whose shape changes. The shaping device 10 shapes the fiber sheet S having a planar shape into a shape having the shape change portion D. In Embodiment 1, a sheet obtained by impregnating reinforcing fibers with resin is applied as the fiber sheet S, and for example, a prepreg is applied. In Embodiment 1, a prepreg is applied as the fiber sheet S. However, there is no particular limitation to this configuration, and a dry reinforcing fiber sheet that does not contain resin may be applied. Further, in Embodiment 1, the fiber sheet S is a laminate in which a plurality of layers are laminated. However, it may be a single layer, and there is no particular limitation.

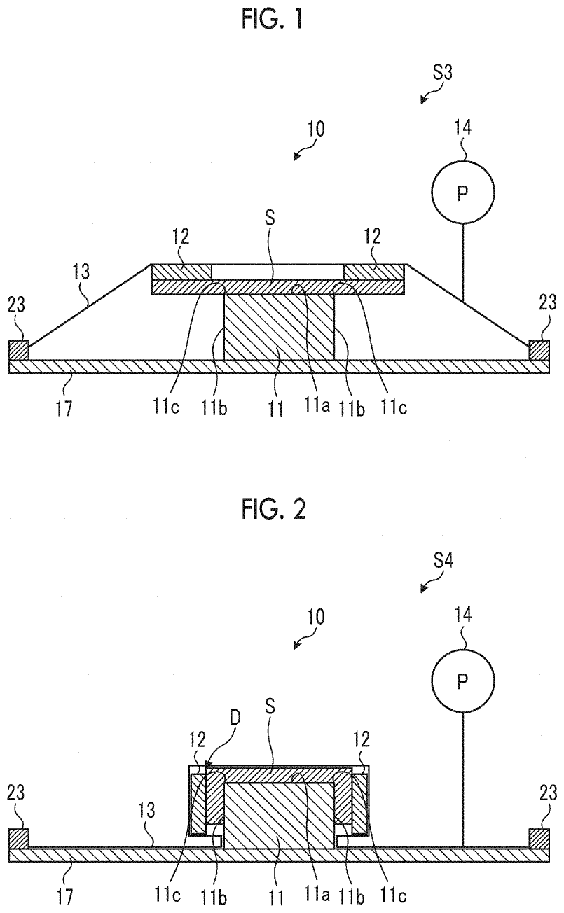

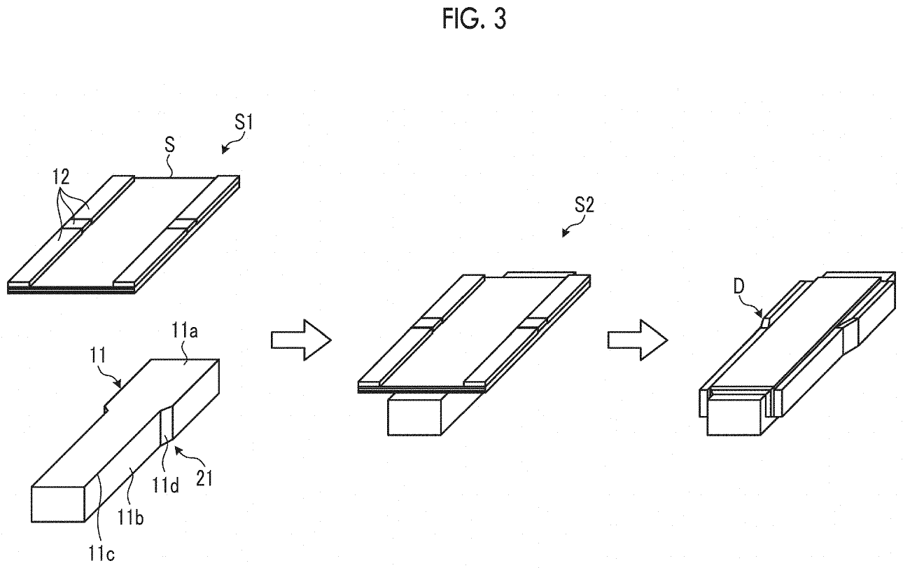

FIG. 1 is a schematic diagram relating to the shaping device before suction according to Embodiment 1. FIG. 2 is a schematic diagram relating to the shaping device after suction according to Embodiment 1. FIG. 3 is a schematic diagram relating to the disposition of the fiber sheet according to Embodiment 1. As shown in FIGS. 1 to 3, the shaping device 10 includes a shaping tool 11, a supporting member 12, a covering member 13, and a suction device 14.

The shaping tool 11 is disposed on a base 17 and serves as a die material for shaping the fiber sheet S. As shown in FIGS. 1 to 3, the shaping tool 11 is a male die that protrudes upward, and is a shaping tool 11 long in a depth direction. As shown in FIGS. 1 and 2, the shaping tool 11 has an upper surface portion 11a, a pair of side surface portions 11b provided on both sides in a width direction of the upper surface portion 11a, and a pair of bent portions 11c formed between the upper surface portion 11a and the pair of side surface portions 11b. The bent portion 11c is, for example, a bent portion 11c made such that the angle formed by the upper surface portion 11a and each of the side surface portions 11b is a right angle.

Further, as shown in FIG. 3, the shaping tool 11 has a stepped portion 21 at each of the pair of side surface portions 11b. The stepped portion 21 includes the side surface portion 11b on one side (the front side) in the depth direction, the side surface portion 11b on the other side (the back side) in the depth direction, and an inclined surface portion 11d between the side surface portions 11b on both sides. The inclined surface portion 11d is an inclined surface that widens in the width direction from one side in the depth direction toward the other side. In this manner, the shaping tool 11 has the bent portion 11c and the stepped portion 21, and the shape change portion D is shaped in the fiber sheet S by the bent portion 11c and the stepped portion 21.

The supporting member 12 is provided on the other side of the shaping tool 11 with the fiber sheet S interposed therebetween. That is, the shaping tool 11 is provided on one side of the fiber sheet S, and the supporting member 12 is provided on the other side of the fiber sheet S. The supporting member 12 has higher rigidity than the fiber sheet S, and for example, a metallic material or an elastic material such as silicone rubber is applied. The supporting member 12 is provided between the fiber sheet S and the covering member 13 and is provided integrally with the fiber sheet S. Specifically, the supporting member 12 is integrated by being attached onto the fiber sheet S through a pressure-sensitive adhesive. The pressure-sensitive adhesive may be omitted, and the supporting member 12 may be integrated by the resin contained in the fiber sheet S.

The supporting member 12 is provided at a portion of the fiber sheet S where the shape change portion D is formed. As shown in FIG. 3, a plurality of supporting members 12 are provided with respect to the shape change portion D of the fiber sheet S. Specifically, a plurality of supporting members 12 are provided at the portions of the fiber sheet S, which face the pair of side surface portions 11b. The plurality of supporting members 12 are divided and disposed so as to follow the shape of the stepped portion 21 at the time of shaping. Specifically, the plurality of supporting members 12 are disposed side by side in the depth direction, and are provided so as to face the side surface portion 11b on one side (the front side) in the depth direction, the side surface portion 11b on the other side (the back side) in the depth direction, and the inclined surface portion 11d between the side surface portions 11b on both sides. The position where the supporting member 12 is provided is not particularly limited to the position described above, and may be provided at any position as long as it is a portion where wrinkles easily occur.

As shown in FIGS. 1 and 2, the covering member 13 is provided to cover the fiber sheet S. The covering member 13 is, for example, a film body made using silicone rubber or the like. The covering member 13 covers the shaping tool 11 and the fiber sheet S installed on the shaping tool 11, and a seal material 23 is provided between the covering member 13 and the base 17 on which the shaping tool 11 is installed, thereby airtightly sealing the interior.

The suction device 14 sucks the internal atmosphere between the shaping tool 11 and the covering member 13 to press the fiber sheet S against the shaping tool 11 with the covering member 13. The suction device 14 is, for example, a vacuum pump. The suction device 14 shapes the fiber sheet S into a shape following the shaping tool 11 by evacuating the internal atmosphere of the airtightly sealed covering member 13 through a suction port (not shown). The resin contained in the fiber sheet S is cured by heating the fiber sheet S with a heating device (not shown) at the same time as or after the shaping. In Embodiment 1, the suction device 14 is applied. However, any device may be adopted as long as it is a device that presses the fiber sheet S against the shaping tool 11 with the covering member 13.

Next, a shaping method using the shaping device 10 will be described with reference to FIGS. 1 to 3. In this shaping method, the fiber sheet S having a flat plate shape is shaped into a shape having the shape change portion D by shaping it to follow the shaping tool 11.

In the shaping method of Embodiment 1, first, the plurality of supporting members 12 are disposed in advance on the fiber sheet S having a flat plate shape (step S1). In step S1, the fiber sheet S and the plurality of supporting members 12 are integrated by bonding the plurality of supporting members 12 onto the fiber sheet S with a pressure-sensitive adhesive. Subsequently, the fiber sheet S having the plurality of supporting members 12 integrated therewith is disposed on the shaping tool 11 (step S2). In step S2, the shaping tool 11 is located on one side of the fiber sheet S, and the supporting members 12 are located on the other side of the fiber sheet S. Then, in step S2, the fiber sheet S is disposed with respect to the shaping tool 11 such that the plurality of supporting members 12 are located at the portions of the fiber sheet S where the shape change portions are formed.

Thereafter, in the shaping method, as shown in FIG. 1, the covering member 13 is disposed so as to cover the fiber sheet S (step S3). In step S3, the supporting members 12 are located between the covering member 13 and the fiber sheet S. Then, in step S3, the covering member 13 is provided, so that the space between the covering member 13 and the shaping tool 11 is airtightly sealed. Next, in the shaping method, as shown in FIG. 2, the atmosphere between the shaping tool 11 and the covering member 13 is sucked by the suction device 14 (step S4). In step S4, the internal atmosphere of the airtightly sealed covering member 13 is evacuated, so that the fiber sheet S is deformed following the shaping tool 11 due to the atmospheric pressure, and therefore, the fiber sheet S is pressed against the shaping tool 11 by the covering member 13 to be shaped into the fiber sheet S having the shape change portion D.

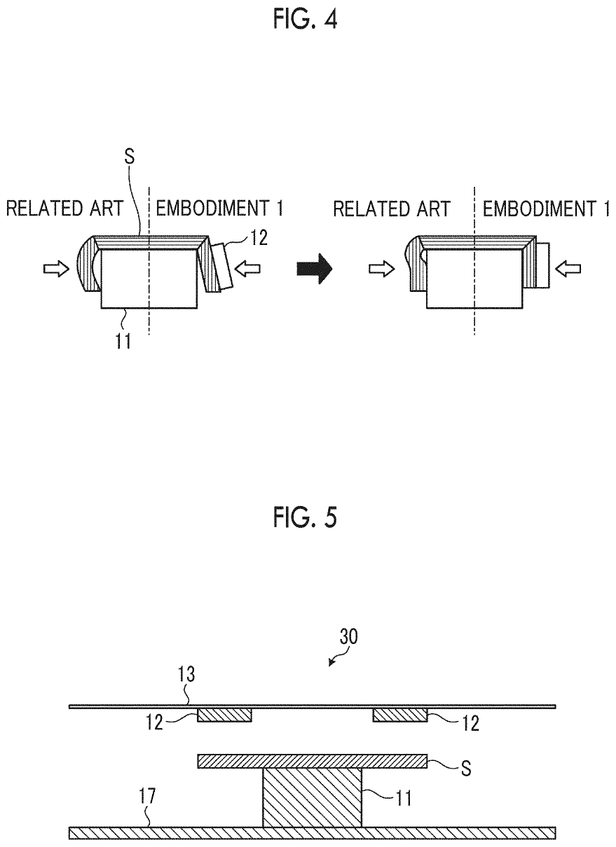

FIG. 4 is an explanatory diagram comparing the shaping in the related art with the shaping in Embodiment 1. The related art is a shaping method in which the supporting member 12 is not provided on the fiber sheet S. In step S4, in a case where the fiber sheet S is deformed, the portion of the fiber sheet S, which is in contact with the upper surface portion 11a of the shaping tool 11, is not deformed, and the portion of the fiber sheet S corresponding to the side surface portion 11b of the shaping tool 11 is bent and deformed so as to approach the side surface portion 11b.

Here, in the case of the related art, since the rigidity of the fiber sheet S is low, in the portion of the fiber sheet S corresponding to the side surface portion 11b, the tip side thereof comes into contact with the shaping tool 11 ahead of the base end side (the upper surface portion 11a side). In this state, when the portion of the fiber sheet S corresponding to the side surface portion 11b is pressed by the atmospheric pressure, the portion on the tip side of the fiber sheet S comes into contact with the shaping tool 11 and is constrained, and therefore, the fiber sheet S is brought into contact with the shaping tool 11 toward the base end side, so that an excess portion of the fiber sheet S is formed on the bent portion 11c of the shaping tool 11. In this way, in the bent portion 11c of the shaping tool 11, the excess portion of the fiber sheet S is shaped as wrinkles.

On the other hand, in the case of Embodiment 1, since the portion of the fiber sheet S corresponding to the side surface portion 11b is supported by the supporting member 12, the rigidity of the fiber sheet S which is being shaped is maintained, so that the fiber sheet S is brought into contact with the shaping tool 11 from the portion on the base end side toward the portion on the tip side. In this way, the formation of an excess portion in the fiber sheet S is suppressed, so that the occurrence of wrinkles is suppressed.

In Embodiment 1, the shape change portion D is formed in the fiber sheet S by using the shaping tool 11 in which the stepped portion 21 having the bent portion 11c is formed. However, there is no limitation to this configuration. For example, the shape change portion D may be formed in the fiber sheet S by using the shaping tool 11 formed with a curved surface. In this case, the supporting member 12 is disposed so as to be able to suppress wrinkles occurring in the fiber sheet S due to the shaping tool 11.

### Embodiment 2

Next, a shaping device 30 according to Embodiment 2 will be described with reference to FIG. 5. In Embodiment 2, portions different from those in Embodiment 1 will be described in order to avoid redundant description, and portions having the same configurations as in Embodiment 1 will be described with the same reference numerals applied thereto. FIG. 5 is a schematic diagram of the shaping device according to Embodiment 2.

In the shaping device 30 of Embodiment 2, the supporting member 12 is provided integrally with the covering member 13. Specifically, the supporting member 12 is integrated with the covering member 13 by being bonded to the surface of the covering member 13 facing the fiber sheet S through an adhesive. On the other hand, the supporting member 12 is not integrated with the fiber sheet S and can be separated.

Therefore, in a shaping method using the shaping device 30 of Embodiment 2, the plurality of supporting members 12 are disposed in advance with respect to the covering member 13 in step S1 in Embodiment 1. Subsequently, after the fiber sheet S is disposed with respect to the shaping tool 11 in step S2, in step S3, the covering member 13 having the plurality of supporting members 12 integrated therewith is disposed so as to cover the fiber sheet S. Then, in step S4, the atmosphere between the shaping tool 11 and the covering member 13 is sucked by the suction device 14 (step S4).

### Embodiment 3

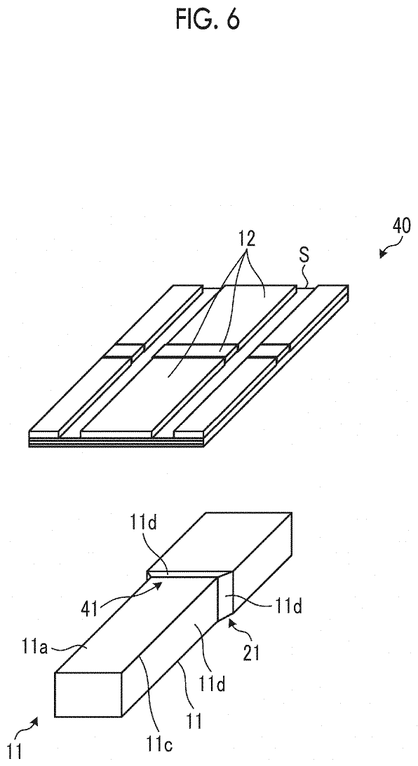

Next, a shaping device 40 according to Embodiment 3 will be described with reference to FIG. 6. In Embodiment 3, portions different from those in Embodiments 1 and 2 will be described in order to avoid redundant description, and portions having the same configurations as in Embodiments 1 and 2 will be described with the same reference numerals applied thereto. FIG. 6 is a schematic diagram relating to the disposition of the supporting member of the shaping device according to Embodiment 3.

In the shaping device 40 of Embodiment 3, as shown in FIG. 6, a plurality of supporting members 12 are provided with respect to the shape change portion D of the fiber sheet S. Specifically, in the shaping tool 11, a stepped portion 41 similar to the stepped portion 21 provided on the side surface portion 11b of Embodiment 1 is also provided on the upper surface portion 11a. The plurality of supporting members 12 are provided with respect to the portions of the fiber sheet S, which face the upper surface portion 11a and the pair of side surface portions 11b. The plurality of supporting members 12 are provided side by side in the depth direction. The plurality of supporting members 12 are provided so as to face the upper surface portion 11a on one side (the front side) in the depth direction, the upper surface portion 11a on the other side (the back side) in the depth direction, and the inclined surface portion 11d between the upper surface portions 11a on both sides. Further, the plurality of supporting members 12 are provided so as to face the side surface portion 11b on one side (the front side) in the depth direction, the side surface portion 11b on the other side (the back side) in the depth direction, and the inclined surface portion 11d between the side surface portions 11b on both sides, as in Embodiment 1.

The plurality of supporting members 12 may be made of different materials, and for example, a metallic material and a composite material may be applied. Further, the plurality of supporting members 12 may have different rigidity, and for example, in a case of using a composite material, the rigidity may be changed by changing a fiber content.

### Embodiment 4

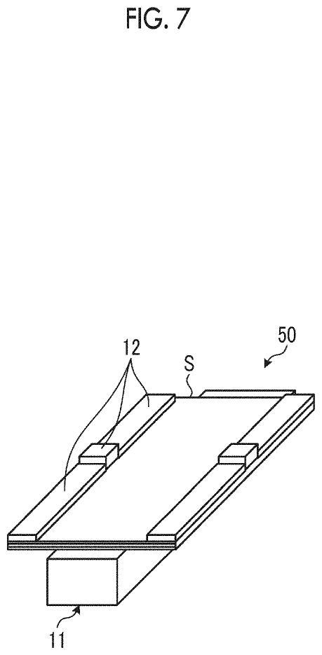

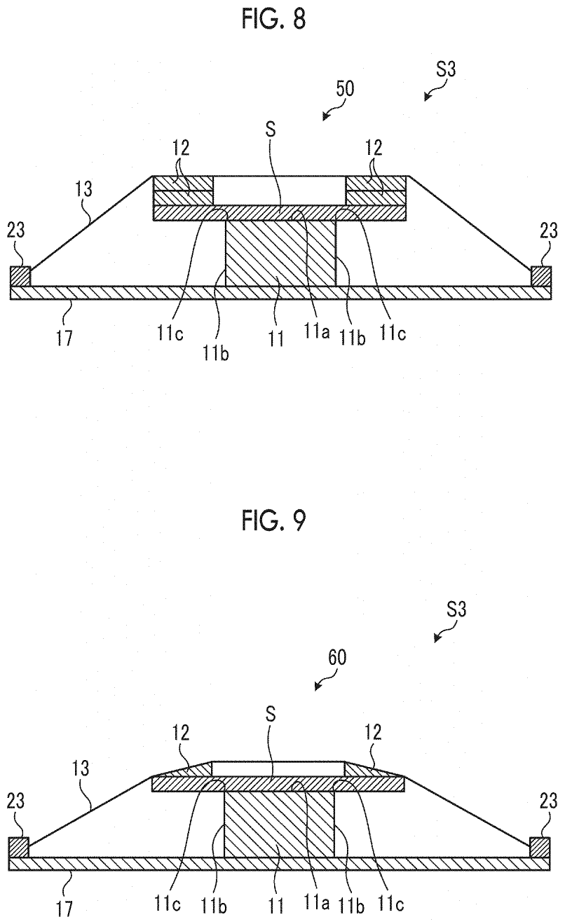

Next, a shaping device 50 according to Embodiment 4 will be described with reference to FIGS. 7 and 8. In Embodiment 4, portions different from those in Embodiments 1 to 3 will be described in order to avoid redundant description, and portions having the same configurations as in Embodiments 1 to 3 will be described with the same reference numerals applied thereto. FIG. 7 is a schematic diagram relating to the disposition of the supporting member of the shaping device according to Embodiment 4. FIG. 8 is a schematic diagram of the shaping device according to Embodiment 4.

In the shaping device 50 of Embodiment 4, the plurality of supporting members 12 have thicknesses different from each other. Specifically, as shown in FIG. 7, in the plurality of supporting members 12 corresponding to the side surface portions 11b in Embodiment 1, the supporting member 12 facing the side surface portion 11b on one side (the front side) in the depth direction and the supporting member 12 facing the side surface portion 11b on the other side (the back side) in the depth direction are made to be thin. On the other hand, in the plurality of supporting members 12, the supporting member 12 facing the inclined surface portion 11d between the side surface portions 11b on both sides is made to be thick.

Among the plurality of supporting members 12, the supporting member 12 having a thick thickness is provided at the portion of the fiber sheet S that is brought into contact with the shaping tool 11 at an early stage, and the supporting member 12 having a thin thickness is provided at the portion of the fiber sheet S that is brought into contact with the shaping tool 11 at a later stage than the supporting member 12 having a thick thickness. Therefore, in a shaping method using the shaping device 50 of Embodiment 4, when the atmosphere between the shaping tool 11 and the covering member 13 is sucked by the suction device 14 in step S4 of Embodiment 1, the portion of the fiber sheet S corresponding to the thick supporting member 12 comes into contact with the shaping tool 11 first, and then the portion of the fiber sheet S corresponding to the thin supporting member 12 comes into contact with the shaping tool 11 later.

### Embodiment 5

Next, a shaping device 60 according to Embodiment 5 will be described with reference to FIG. 9. In Embodiment 5, portions different from those in Embodiments 1 to 4 will be described in order to avoid redundant description, and portions having the same configurations as in Embodiments 1 to 4 will be described with the same reference numerals applied thereto. FIG. 9 is a schematic diagram of the shaping device according to Embodiment 5.

In the shaping device 60 of Embodiment 5, the thickness of the supporting member 12 is changed. Specifically, as shown in FIG. 9, the thickness of the supporting member 12 as a single body is made to be thick at the portion on the upper surface portion 11a side in the width direction and decrease toward the tip side in the width direction.

The thick portion of the supporting member 12 is located at the portion of the fiber sheet S that is brought into contact with the shaping tool 11 at an early stage. Further, the thin portion of the supporting member 12 is located at the portion of the fiber sheet S that is brought into contact with the shaping tool 11 at a later stage than the thick portion.

Therefore, in a shaping method using the shaping device 60 of Embodiment 5, when the atmosphere between the shaping tool 11 and the covering member 13 is sucked by the suction device 14 in step S4 of Embodiment 1, the portion of the fiber sheet S corresponding to the thick portion of the supporting member 12 comes into contact with the shaping tool 11 first, and then the portion of the fiber sheet S corresponding to the thin portion of the supporting member 12 comes into contact with the shaping tool 11 later.

### Embodiment 6

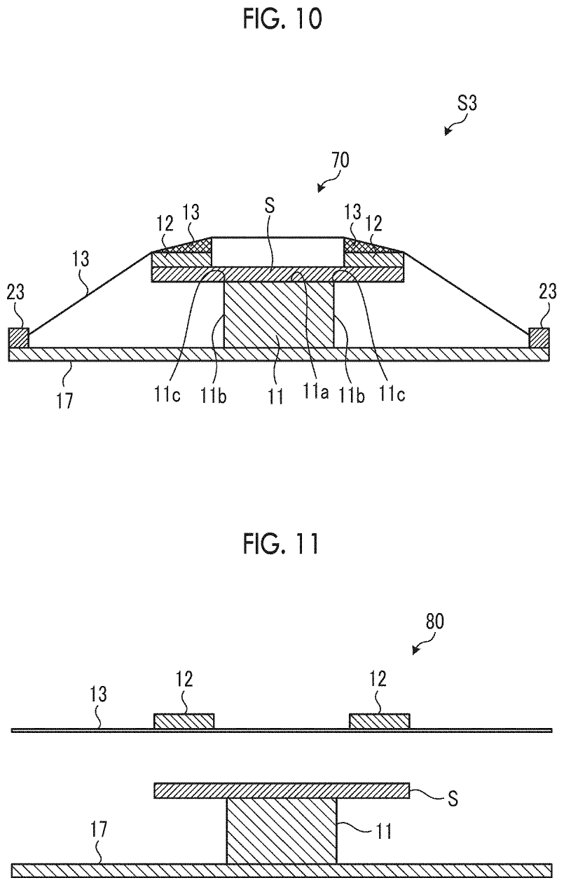

Next, a shaping device 70 according to Embodiment 6 will be described with reference to FIG. 10. In Embodiment 6, portions different from those in Embodiments 1 to 5 will be described in order to avoid redundant description, and portions having the same configurations as in Embodiments 1 to 5 will be described with the same reference numerals applied thereto. FIG. 10 is a schematic diagram of the shaping device according to Embodiment 6.

In the shaping device 70 of Embodiment 6, the thickness of the covering member 13 is changed. Specifically, as shown in FIG. 10, the thickness of the covering member 13 is changed at the portion facing the supporting member 12. Specifically, the thickness of the covering member 13 is made to be thick at the portion on the upper surface portion 11a side in the width direction with respect to the supporting member 12, and the thickness decreases toward the tip side in the width direction.

The thick portion of the covering member 13 is located at the portion of the fiber sheet S that is brought into contact with the shaping tool 11 at an early stage. Further, the thin portion of the covering member 13 is located at the portion of the fiber sheet S that is brought into contact with the shaping tool 11 at a later stage than the thick portion.

Therefore, in a shaping method using the shaping device 70 of Embodiment 6, when the atmosphere between the shaping tool 11 and the covering member 13 is sucked by the suction device 14 in step S4 of Embodiment 1, the portion of the fiber sheet S corresponding to the thick portion of the covering member 13 comes into contact with the shaping tool 11 first, and then the portion of the fiber sheet S corresponding to the thin portion of the covering member 13 comes into contact with the shaping tool 11 later.

In the covering member 13 of Embodiment 6, as shown in FIG. 10, the thickness in the width direction is changed. However, the thickness in the depth direction may be changed, and there is no particular limitation.

### Embodiment 7

Next, a shaping device 80 according to Embodiment 7 will be described with reference to FIG. 11. In Embodiment 7, portions different from those in Embodiments 1 to 6 will be described in order to avoid redundant description, and portions having the same configurations as in Embodiments 1 to 6 will be described with the same reference numerals applied thereto. FIG. 11 is a schematic diagram of the shaping device according to Embodiment 7.

In the shaping device 80 of Embodiment 7, the supporting member 12 is integrally provided on the outer side of the covering member 13. Specifically, the supporting member 12 is bonded to the surface (the outer surface) on the side opposite to the surface (the inner surface) of the covering member 13 facing the fiber sheet S through an adhesive, so that the supporting member 12 is integrated with the covering member 13.

Therefore, in a shaping method using the shaping device 80 of Embodiment 7, in step S1 in Embodiment 1, a plurality of supporting members 12 are disposed in advance with respect to the outer surface of the covering member 13. Subsequently, after the fiber sheet S is disposed with respect to the shaping tool 11 in step S2, in step S3, the covering member 13 having the plurality of supporting members 12 integrated therewith is disposed so as to cover the fiber sheet S. Then, in step S4, the atmosphere between the shaping tool 11 and the covering member 13 is sucked by the suction device 14 (step S4). Here, in step S4, the covering member 13 is in a state of being supported by the plurality of supporting members 12. Therefore, the covering member 13 comes into contact with the fiber sheet S from the base end side (the upper surface portion 11a side) toward the tip side in the width direction. In this way, the fiber sheet S comes into contact with the shaping tool 11 from the portion on the base end side (the upper surface portion 11a side) toward the portion on the tip side. In this way, the formation of an excess portion in the fiber sheet S is suppressed, so that the occurrence of wrinkles is suppressed.

### Embodiment 8

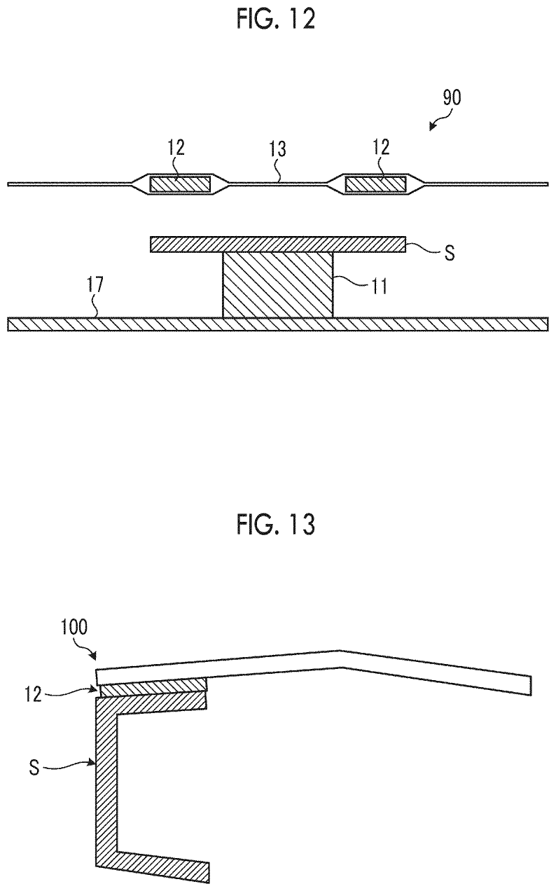

Next, a shaping device 90 according to Embodiment 8 will be described with reference to FIG. 12. In Embodiment 8, portions different from those in Embodiments 1 to 7 will be described in order to avoid redundant description, and portions having the same configurations as in Embodiments 1 to 7 will be described with the same reference numerals applied thereto. FIG. 12 is a schematic diagram of the shaping device according to Embodiment 8.

In the shaping device 90 of Embodiment 8, the supporting member 12 is integrally provided in the interior of the covering member 13. Specifically, the supporting member 12 is integrally molded in advance so as to be included in the interior of the covering member 13. The supporting member 12 may be made of the same material as the covering member 13.

Therefore, in a shaping method using the shaping device 90 of Embodiment 8, in step S1 in Embodiment 1, the covering member 13 having a plurality of supporting members 12 integrated therewith is prepared in advance. Subsequently, after the fiber sheet S is disposed with respect to the shaping tool 11 in step S2, in step S3, the covering member 13 having the plurality of supporting members 12 integrated therewith is disposed so as to cover the fiber sheet S. Then, in step S4, the atmosphere between the shaping tool 11 and the covering member 13 is sucked by the suction device 14 (step S4). Here, in step S4, the covering member 13 is in a state of being supported by the plurality of supporting members 12. Therefore, the covering member 13 comes into contact with the fiber sheet S from the base end side (the upper surface portion 11a side) toward the tip side in the width direction. In this way, the fiber sheet S comes into contact with the shaping tool 11 from the portion on the base end side (the upper surface portion 11a side) toward the portion on the tip side. In this way, the formation of an excess portion in the fiber sheet S is suppressed, so that the occurrence of wrinkles is suppressed.

### Embodiment 9

Next, a shaping method according to Embodiment 9 will be described with reference to FIG. 13. In Embodiment 9, portions different from those in Embodiments 1 to 8 will be described in order to avoid redundant description, and portions having the same configurations as in Embodiments 1 to 8 will be described with the same reference numerals applied thereto. FIG. 13 is an explanatory diagram of the shaping method according to Embodiment 9.

In the shaping method of Embodiment 9, in step S1 of Embodiment 1, instead of a pressure-sensitive adhesive, an adhesive is disposed between the fiber sheet S and the supporting member 12. In a case where the fiber sheet S is self-adhesive, an adhesive does not need to be disposed. That is, the shaping method of Embodiment 9 is a shaping method in which the fiber sheet S and the supporting member 12 are integrated by being bonded together with an adhesive or the like after the shaping of the fiber sheet S. Further, in the shaping method of Embodiment 9, a step of processing the supporting member 12 bonded to the fiber sheet S after the shaping is executed.

As shown in FIG. 13, as an example, another member 100 is joined to the supporting member 12 bonded to the fiber sheet S. Specifically, the fiber sheet S after curing is a spar, and the other member is a skin 100. In this case, the supporting member 12 functions as a shim for adjusting the gap between the spar and the skin. In the shaping method of Embodiment 9, after the shaping of the fiber sheet S, the supporting member 12 is processed so as to have a shape complementary to the gap between the spar and the skin.

As described above, the shaping devices 10, 30, 40, 50, 60, 70, 80, and 90 and the shaping method according to the present embodiments are grasped as follows, for example.

The shaping device 10, 30, 40, 50, 60, 70, 80, or 90 according to a first aspect is the shaping device 10, 30, 40, 50, 60, 70, 80, or 90 for shaping the fiber sheet S into a shape having the shape change portion D, including: the shaping tool 11 that is provided on one side of the fiber sheet S and serves as a die material for shaping the fiber sheet S; the supporting member 12 that has higher rigidity than the fiber sheet S and is provided on the other side of the fiber sheet S and provided at a portion where the shape change portion D is formed; the covering member 13 that covers the fiber sheet S; and a pressing device that presses the fiber sheet S against the shaping tool 11 with the covering member 13.

As a second aspect, the pressing device is the suction device 14 that sucks the atmosphere between the shaping tool 11 and the covering member 13.

According to this configuration, since the shape change portion D can be shaped by the supporting member 12 without forming an excess portion in the fiber sheet S, the fiber sheet S having the shape change portion D can be shaped suitably.

As a third aspect, the supporting member 12 is provided between the fiber sheet S and the covering member 13.

According to this configuration, the shape of the fiber sheet S can be changed by bringing the supporting member 12 into contact with the fiber sheet S.

As a fourth aspect, the supporting member 12 is provided integrally with the fiber sheet S.

According to this configuration, since the shape of the fiber sheet S can be supported by the supporting member 12, the portion of the fiber sheet S, which is provided with the supporting member 12, can be appropriately shaped following the shaping tool 11.

As a fifth aspect, the supporting member 12 is provided integrally with the covering member 13.

According to this configuration, the shape of the covering member 13 is supported by the supporting member 12, so that the covering member 13 can be brought into contact with the fiber sheet S so as not to form an excess portion. Further, since the supporting member 12 can be handled integrally with the covering member 13, it is not necessary to adjust the position of the supporting member 12 with respect to the fiber sheet S, so that working efficiency can be improved.

As a sixth aspect, a plurality of the supporting members 12 are provided with respect to the shape change portion D.

According to this configuration, since the plurality of supporting members 12 can conform to the shape of the shape change portion D of the fiber sheet S at the time of the shaping, the fiber sheet S can be shaped suitably.

As a seventh aspect, the plurality of supporting members 12 have thicknesses different from each other, in which the thickness of the supporting member 12 corresponding to the portion of the fiber sheet S that is brought into contact with the shaping tool 11 at an early stage is set to be thick, and the thickness of the supporting member 12 corresponding to the portion of the fiber sheet S that is brought into contact with the shaping tool 11 at a later stage is set to be thin.

According to this configuration, since a timing at which the fiber sheet S is brought into contact with the shaping tool 11 can be adjusted, the fiber sheet S having the shape change portion D can be shaped more suitably.

As an eighth aspect, the thickness of the supporting member 12 is changed, in which the thickness of the portion of the supporting member 12 corresponding to the portion of the fiber sheet S that is brought into contact with the shaping tool 11 at an early stage is set to be thick, and the thickness of the portion of the supporting member 12 corresponding to the portion of the fiber sheet S that is brought into contact with the shaping tool 11 at a later stage is set to be thin.

According to this configuration, since a timing at which the fiber sheet S is brought into contact with the shaping tool 11 can be adjusted, the fiber sheet S having the shape change portion D can be shaped more suitably.

As a ninth aspect, the thickness of the covering member 13 is changed, in which the thickness of the portion of the covering member 13 corresponding to the portion of the fiber sheet S that is brought into contact with the shaping tool 11 at an early stage is set to be thick, and the thickness of the portion of the covering member 13 corresponding to the portion of the fiber sheet S that is brought into contact with the shaping tool 11 at a later stage is set to be thin.

According to this configuration, since a timing at which the fiber sheet S is brought into contact with the shaping tool 11 can be adjusted, the fiber sheet S having the shape change portion D can be shaped more suitably.

As a tenth aspect, the supporting member 12 is integrally provided in the interior of the covering member 13.

According to this configuration, the shape of the covering member 13 is supported by the supporting member 12, so that the covering member 13 can be brought into contact with the fiber sheet S so as not to form an excess portion. Further, since the supporting member 12 can be handled integrally with the covering member 13, it is not necessary to adjust the position of the supporting member 12 with respect to the fiber sheet S, so that working efficiency can be improved.

As an eleventh aspect, the supporting member 12 is integrally provided on the outer side of the covering member 13.

According to this configuration, the shape of the covering member 13 is supported by the supporting member 12, so that the covering member 13 can be brought into contact with the fiber sheet S so as not to form an excess portion. Further, since the supporting member 12 can be handled integrally with the covering member 13, it is not necessary to adjust the position of the supporting member 12 with respect to the fiber sheet S, so that working efficiency can be improved.

A shaping method according to a twelfth aspect is a shaping method for shaping the fiber sheet S into a shape having the shape change portion D by using the shaping device 10 described above, the method including: step S2 of disposing the fiber sheet S with respect to the shaping tool 11; step S1 of disposing the supporting member 12 on the opposite side of the shaping tool 11 with the fiber sheet S interposed therebetween, corresponding to a portion where the shape change portion D is formed, before or after the step S2 of disposing the fiber sheet S; step S3 of disposing the covering member 13 to cover the fiber sheet S; and step S4 of sucking the atmosphere between the shaping tool 11 and the covering member 13.

According to this configuration, since the shape change portion D can be shaped by the supporting member 12 without forming an excess portion in the fiber sheet S, the fiber sheet S having the shape change portion D can be shaped suitably.

As a thirteenth aspect, in step S1 of disposing the supporting member, the fiber sheet S and the supporting member 12 are disposed to be joined together, and the method further includes a step of processing the supporting member 12 joined to the fiber sheet S after shaping.

According to this configuration, by processing the supporting member 12, it becomes possible to cause the supporting member 12 to function as, for example, a member such as a shim. Therefore, the supporting member 12 joined to the fiber sheet S can be effectively utilized.

### REFERENCE SIGNS LIST

10 shaping device
11 shaping tool
11a upper surface portion
11b side surface portion
11c bent portion
11d inclined surface portion
12 supporting member
13 covering member
14 suction device
17 base
21 stepped portion
23 seal material
30 shaping device (embodiment 2)
40 shaping device (embodiment 3)
41 stepped portion
50 shaping device (embodiment 4)
60 shaping device (embodiment 5)
70 shaping device (embodiment 6)
80 shaping device (embodiment 7)
90 shaping device (embodiment 8)
S fiber sheet
D shape change portion

1. A shaping device for shaping a fiber sheet into a shape having a shape change portion, comprising:
a shaping tool that is provided on one side of the fiber sheet and serves as a die material for shaping the fiber sheet;
a supporting member that has higher rigidity than the fiber sheet and is provided on the other side of the fiber sheet and provided at a portion where the shape change portion is formed;
a covering member that covers the fiber sheet; and
a pressing device that presses the fiber sheet against the shaping tool with the covering member.

2. The shaping device according to claim 1, wherein the pressing device is a suction device that sucks an atmosphere between the shaping tool and the covering member.

3. The shaping device according to claim 1, wherein the supporting member is provided between the fiber sheet and the covering member.

4. The shaping device according to claim 3, wherein the supporting member is provided integrally with the fiber sheet.

5. The shaping device according to claim 3, wherein the supporting member is provided integrally with the covering member.

6. The shaping device according to claim 1, wherein a plurality of the supporting members are provided with respect to the shape change portion.

7. The shaping device according to claim 6, wherein the plurality of supporting members have thicknesses different from each other, in which a thickness of the supporting member corresponding to a portion of the fiber sheet that is brought into contact with the shaping tool at an early stage is set to be thick, and a thickness of the supporting member corresponding to a portion of the fiber sheet that is brought into contact with the shaping tool at a later stage is set to be thin.

8. The shaping device according to claim 3, wherein a thickness of the supporting member is changed, in which a thickness of a portion of the supporting member corresponding to a portion of the fiber sheet that is brought into contact with the shaping tool at an early stage is set to be thick, and a thickness of a portion of the supporting member corresponding to a portion of the fiber sheet that is brought into contact with the shaping tool at a later stage is set to be thin.

9. The shaping device according to claim 3, wherein a thickness of the covering member is changed, in which a thickness of a portion of the covering member corresponding to a portion of the fiber sheet that is brought into contact with the shaping tool at an early stage is set to be thick, and a thickness of a portion of the covering member corresponding to a portion of the fiber sheet that is brought into contact with the shaping tool at a later stage is set to be thin.

10. The shaping device according to claim 3, wherein the supporting member is integrally provided in an interior of the covering member.

11. The shaping device according to claim 3, wherein the supporting member is integrally provided on an outer side of the covering member.

12. A shaping method for shaping the fiber sheet into a shape having the shape change portion by using the shaping device according to claim 1, the method comprising:
a step of disposing the fiber sheet with respect to the shaping tool;
a step of disposing the supporting member on an opposite side of the shaping tool with the fiber sheet interposed therebetween, corresponding to a portion where the shape change portion is formed, before or after the step of disposing the fiber sheet;
a step of disposing the covering member to cover the fiber sheet; and
a step of pressing the fiber sheet against the shaping tool with the covering member.

13. The shaping method according to claim 12, wherein in the step of disposing the supporting member, the fiber sheet and the supporting member are disposed to be joined together, and
the method further comprises a step of processing the supporting member joined to the fiber sheet after shaping.
